(19) United States
(12) Patent Application Publication
(10) Pub. No.: US 2017/0335966 A1
(43) Pub. Date: Nov. 23, 2017

(54) SHAFT SEAL ARRANGEMENT FOR A FLUID MACHINE AND METHOD FOR SEALING A SHAFT OF A FLUID MACHINE

(71) Applicant: EagleBurgmann Germany GmbH & Co. KG, Wolfratshausen (DE)

(72) Inventors: Ferdinand Werdecker, Walchensee (DE); Michael Müller, Bichl (DE)

(73) Assignee: EagleBurgmann Germany GmbH & Co. KG, Wolfratshausen (DE)

(21) Appl. No.: 15/531,639

(22) PCT Filed: Nov. 3, 2015
(86) PCT No.: PCT/EP2015/075548

§ 371 Date: May 30, 2017

(30) Foreign Application Priority Data
Dec. 18, 2014 (DE) 10 2014 226 429.4

(51) Int. Cl. F16J 15/00; F04D 29/10; F16J 15/447; F01D 11/00; F16J 15/34; F01D 11/02; F04D 29/053

(52) U.S. Cl. CPC F16J 15/006; F16J 15/447; F04D 29/102; F01D 11/003; F01D 11/02; F04D 29/053; F05D 2240/60; F16J 15/3492

(57) ABSTRACT

The invention relates to a shaft seal arrangement, comprising a first seal, a second seal and a third seal which are arranged in series between a product side to be sealed and an atmosphere side, wherein the second seal is arranged between the first seal and the third seal, wherein a first pressure is present in a space adjacent to the second seal in the direction towards the product side, and a second pressure is present in a space adjacent to the second seal in the direction towards the atmosphere side, wherein the space that is adjacent to the atmosphere side is connected to a pressure supply line via which a pressure medium can be supplied into the space, and wherein the first pressure is equal or substantially equal to the second pressure, so that the second seal can be operated with a pressure difference of zero between the first pressure and the second pressure.

The present invention relates to a shaft seal arrangement of a fluid machine, such as for example of a power plant turbine or of a compressor, a fluid machine with such a shaft seal arrangement, as well as to a method for providing sealing at a shaft of a fluid machine.

What is used for sealing fluid machines, such as for example power plant turbines or compressors, are liquid-lubricated mechanical seals that are sealed by means of a sealing medium containing oil. Further, there are application cases for expansion turbines, which are for example used in the Organic Rankine Cycle (ORC) method or in geothermal applications. In these cases, mediums are not to be discharged into the environment in the form of leakage for health reasons and environmental or security reasons. However, the use of the liquid-lubricated oil seals makes elaborate leakage recirculation systems necessary. Further, oil treatment systems have to be provided, since the oil which is used as the sealing medium comes into contact with the dangerous media. As a result, the cost of such systems is extremely high. Further, high rotational speeds of the shafts in the range of 40 m/s to 140 m/s occur in such applications, wherein oil seals can only be used for rotational speeds of up to 80 m/s.

It is thus the objective of the present invention to provide a shaft seal arrangement of a fluid machine for providing sealing at a shaft that facilitates a leakage-free sealing at the shaft while at the same time being characterized by an easy and cost-effective structure as well as use of a gas-lubricated mechanical seal. Further, it is the objective of the present invention to provide a fluid machine with such a shaft seal arrangement as well as a method for operating such a shaft seal arrangement.

This objective is achieved by a shaft seal arrangement with the features of claim 1 or a fluid machine with the features of claim 15 or a method with the features of claim 16. The subclaims respectively show preferably further developments of the invention.

The shaft seal arrangement according to the invention with the features of claim 1 has the advantage that any leakage of the product medium can be completely avoided during operation. At the same time, the shaft seal arrangement has a simple and cost-effective design. According to the invention, this is achieved by providing a first, second and third seal which are arranged in series between a product side to be sealed and an atmosphere side. A first space with a first pressure is defined between the first and the second seal, and a second space with a second pressure is defined between the second and the third seal. Here, the first pressure is equal or substantially equal to the second pressure. What is understood here by “substantially equal” according to the invention is that the pressure difference between the first and the second space is equal to or less than 1%, in particular equal to or less than 0.5%, in particular equal to or less than 0.2%.

In other words, the pressure difference between the first and the second space should go towards zero or be zero. The first space is further connected to the product side in order to supply a product medium having a predefined pressure to the first space. The second space is connected to a pressure supply line via which pressure medium (sealing medium) can be supplied to the second space. At that, the pressures inside the first and second space are equal or substantially equal, so that the middle seal, i.e. the second seal, can be operated with a pressure difference of zero. In this manner, any leakage of the product medium that is present inside the first space into the second space can be avoided. In this manner, zero leakage can be realized during operation. Leakage may occur in small amounts from the first space via the first seal back to the product side, or from the second space, which is filled with the environmentally friendly pressure medium (sealing medium), to the atmosphere side. Further, by operating the middle seal with a pressure difference of zero, any contamination of the product medium inside the first space through a leakage via the middle seal from the second space can also be avoided.

Preferably, the second seal is a gas-lubricated mechanical seal with a rotating mechanical seal and a stationary mechanical seal. The gas-lubricated mechanical seal is thus arranged between the first and the second space in which the same pressure or substantially the same pressure is present. Hereby, an effective sealing between the first and the second space can be ensured by means of the mechanical seal.

According to a preferable alternative embodiment of the present invention, the second seal is a radial gap seal, in particular a labyrinth seal or a carbon ring seal. Here, the carbon ring seal is made of a carbon-containing material and preferably has an annular circumferential recess at a side that is orientated towards the rotating structural component. At that, the radial gap seal provides a sealing directly at a rotating structural component, e.g. a shaft or the like. In particular, the radial gap seal has the advantage that it has a very compact structure in the axial direction, so that a common axial length of the shaft seal arrangement can be very small.

Further, the first seal is preferably a radial gap seal, in particular a labyrinth seal or a carbon ring seal. By using a radial gap seal as the first seal, an axial installation length of the shaft seal arrangement can be further reduced.

Further, the shaft seal arrangement preferably also comprises a control unit and a first throttling device that is arranged inside the pressure supply line for the pressure medium to the second space. The first throttling device is connected to the control unit, wherein the control unit is configured for controlling the first throttling device depending on the pressure in the first space, namely in such a way that the pressure in the second space is equal or substantially equal to the pressure in the first space. Here, the control is performed by opening or closing the first throttling device. Thus, according to the invention, an easy reaction to pressure changes in the first space as they may occur during operation is possible in order to adjust the pressure in the second space to the pressure in the first space.

Further, the second seal that is embodied as a gas-lubricated mechanical seal preferably has a diamond coating at least at one of the mechanical seals, preferably at both mechanical seals. In this manner, a particularly reliable sealing of the second seal can be achieved. In addition, a long service life of the second seal can be maintained in this manner.

The pressure medium, which is supplied via the pressure supply line into the second space, is preferably air or nitrogen. In this way, a leakage via the atmosphere-side third seal does not pose any problems from the environmental point of view.

Further, the shaft seal arrangement preferably also comprises a pressure discharge line that branches off from the second space. In this way, in particular a leakage via the third seal to the atmosphere side can be kept as small as possible. Particularly preferably, a second throttling device is arranged inside the pressure discharge line and connected to the control unit. At that, the control unit is configured for controlling the second throttling device depending on the pressure in the first space in order to adjust the pressure in the second space to the pressure in the first space, so that a pressure difference between the two spaces tends towards zero or is zero.

According to a particularly preferable embodiment of the invention, the shaft seal arrangement further comprises a fourth seal that is arranged between the first and the second seal. Here, the fourth seal divides the first space between the first and the second seal into a first subspace between the first and the fourth seal and a second subspace between the fourth and the second seal. At that, the first subspace has a connection to the product side and the second subspace has a product return line to the product side via which product medium can flow from the second subspace back to the product side. Here, a pressure is present in the first subspace that is higher than a pressure in the second subspace. According to the invention, the pressure in the second subspace is equal or substantially equal to the pressure in the second space between the second and the third seal, so that the second seal, which is sealed off towards both sides by respectively at least one further seal, can be operated with a pressure difference of zero.

By providing four seals in series, an additional product return line for the product medium towards the product side can be integrated into the shaft seal arrangement. Three spaces, i.e. the first subspace, the second subspace and the second space, are defined between the four seals. In all three spaces, a pressure higher than the atmospheric pressure is provided. Here, the pressure between the middle space and the atmosphere-side space (second space) is equal or substantially equal, so that the second seal can be operated without any pressure difference. In this way, a leakage of product medium into the second space is successfully avoided.

According to a further preferable embodiment of the present invention, the shaft seal arrangement further has a fifth seal. The fifth seal is arranged between the second and the third seal. At that, the fifth seal divides the second space into a third subspace between the second and the fifth seal, and into a fourth subspace between the fifth and the third seal. Here, the fourth subspace is connected to the pressure supply line. A pressure discharge line branches off from the third subspace. In this way, the second seal, which is operated with a pressure difference of zero, is arranged between the second subspace and the third subspace. The pressures in the second subspace and in the third subspace are equal or substantially equal, so that any leakage via the second seal can be avoided. Thus, in this exemplary embodiment, five seals are arranged in series, whereby four spaces (the first subspace, the second subspace, the third subspace, the fourth subspace) are defined between the five seals. According to the invention, a middle seal, i.e. the second seal, can again be operated with a pressure difference of zero between the product side and the atmosphere side, wherein the two spaces adjacent to the middle seal are maintained at the same or at substantially the same pressure level, which is higher than the atmospheric pressure. Thanks to this measure, it is ensured that leakage of a product medium towards the atmosphere side is rendered impossible. In this manner, dangerous product media can be sealed off in a reliable and cost-effective manner. Further, a pressure in the fourth subspace is higher than a pressure in the third subspace. In this manner, a certain leakage from the fourth subspace into the third subspace is possible, wherein the leakage can subsequently be discharged via the pressure discharge line which branches off from the third subspace.

Further, a shaft seal arrangement with a third throttling device is preferably arranged inside the product return line and connected to the control unit, wherein the control unit is configured for controlling the first pressure by means of opening and closing the third throttling device.

In order to facilitate an even more compact embodiment when providing five seals, the third and the fifth seal are integrated inside a common mechanical seal, wherein the pressure supply line of the pressure medium is guided from a rear side of the stationary common mechanical seal through the stationary mechanical seal and to the sliding surfaces. At that, the fourth subspace between the third and the fifth seal is arranged at the sealing gap of the common mechanical seal. Starting at the fourth subspace, a leakage is possible towards the one side to the atmosphere side, and towards the other side to the third subspace.

An arrangement that is particularly compact and in particular has a compact structure in the axial direction is possible when all seals are preferably embodied as gas-lubricated mechanical seals. Alternatively, the first seal, which provides a sealing towards the product side, can also be a carbon seal or a labyrinth seal.

Further, the invention also relates to a fluid machine that comprises a shaft seal arrangement according to the invention. Particularly preferably, the fluid machine is a turbine, in particular a power plant turbine or a compressor. Further, the fluid machine preferably has a shaft that can be operated with a rotational speed of 40 m/s to 200 m/s, in particular of 90 m/s to 140 m/s.

Further, the present invention relates to a method for operating a shaft seal arrangement which comprises a first, a second and a third seal that are arranged in series at a shaft. Here, the second seal is arranged as a middle seal between the first and the third seal. The three seals that are arranged in series define a first and a second space here, wherein a product medium to be sealed off is supplied to the first space. The second space has a pressurized pressure medium, wherein the pressure in the first space is equal or substantially equal to the pressure in the second space. In this manner, the second seal (middle seal) can be operated without or with only a minimal pressure gradient.

Particularly preferably, the pressure level of the pressure medium in the second space is controlled by means of a throttling device depending on the pressures in the first space. Particularly preferably, the pressure of the product medium that is supplied to the first space is also controlled by means of a throttling device after having been extracted from the product side.

In the following, preferable exemplary embodiments are described in detail by referring to the accompanying drawing. In the drawing, identical or functionally identical parts are indicated by the same reference sings. Herein:

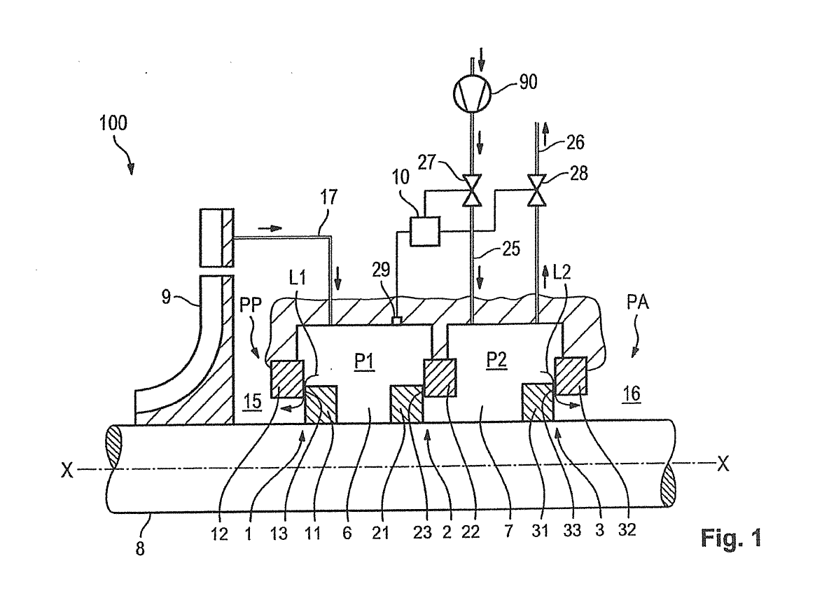

FIG. 1 shows a schematic sectional view of a shaft seal arrangement according to a first exemplary embodiment of the invention,

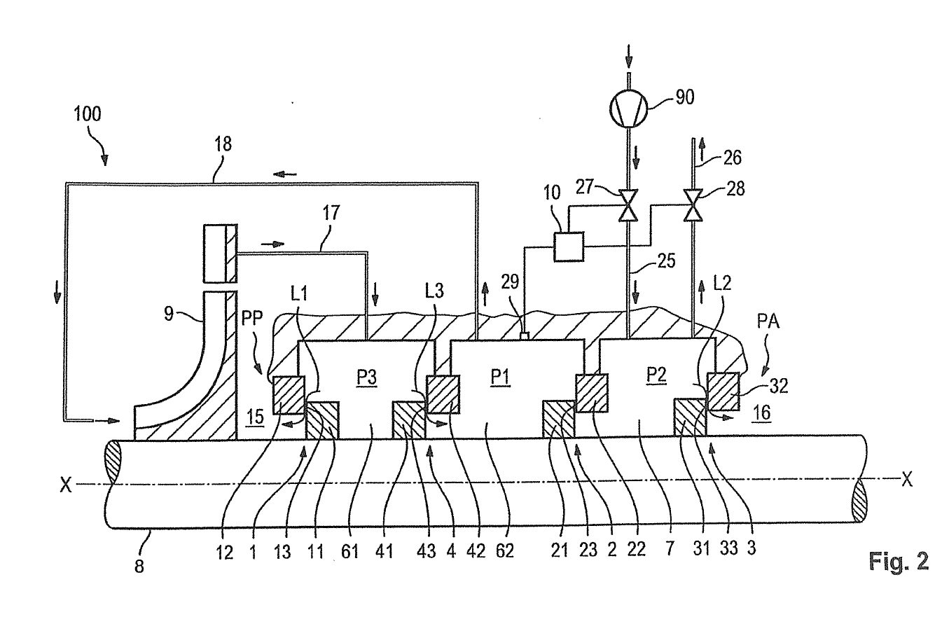

FIG. 2 shows a schematic sectional view of a shaft seal arrangement according to a second exemplary embodiment of the invention,

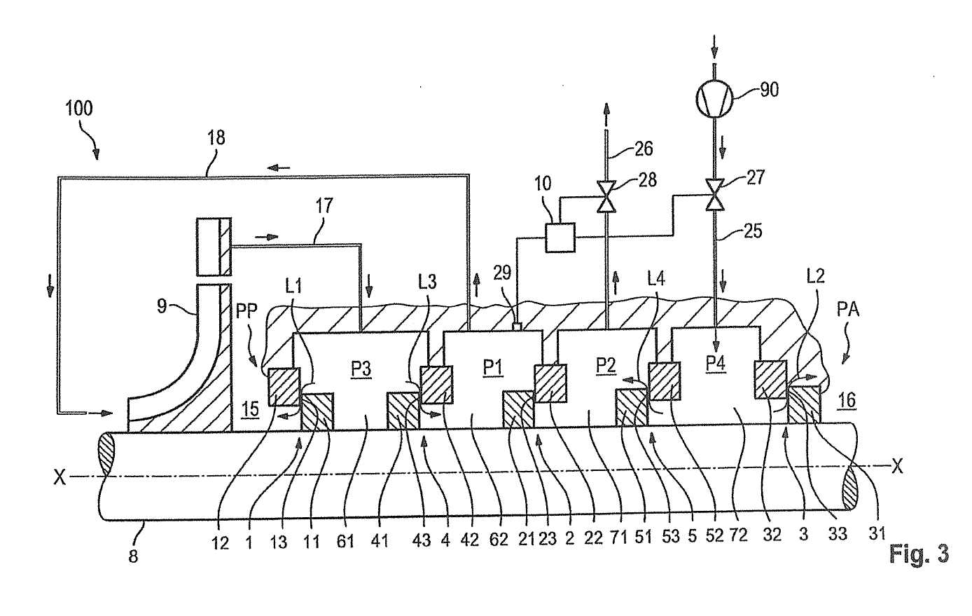

FIG. 3 shows a schematic sectional view of a shaft seal arrangement according to a third exemplary embodiment of the invention,

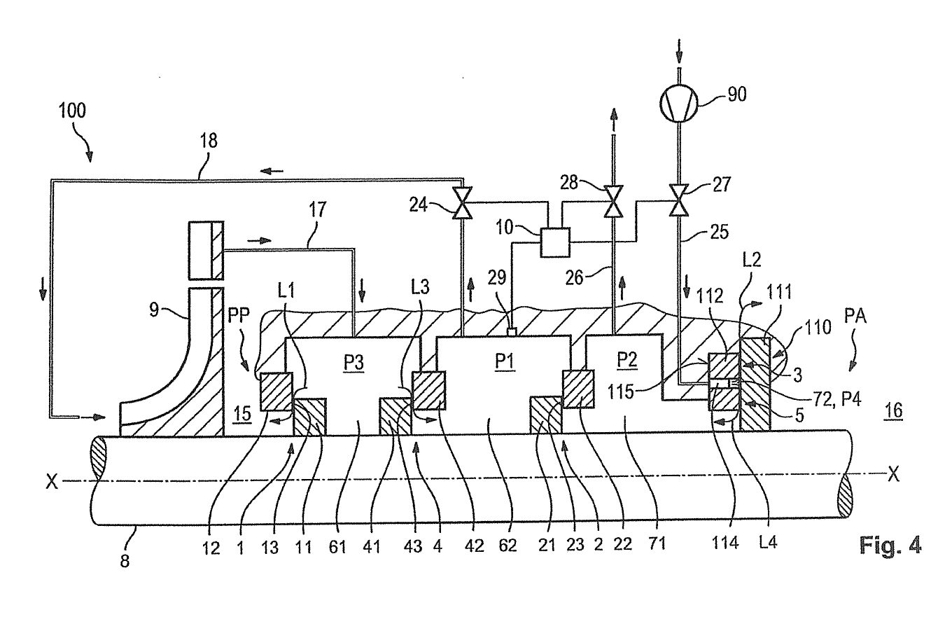

FIG. 4 shows a schematic sectional view of a shaft seal arrangement according to a fourth exemplary embodiment of the invention,

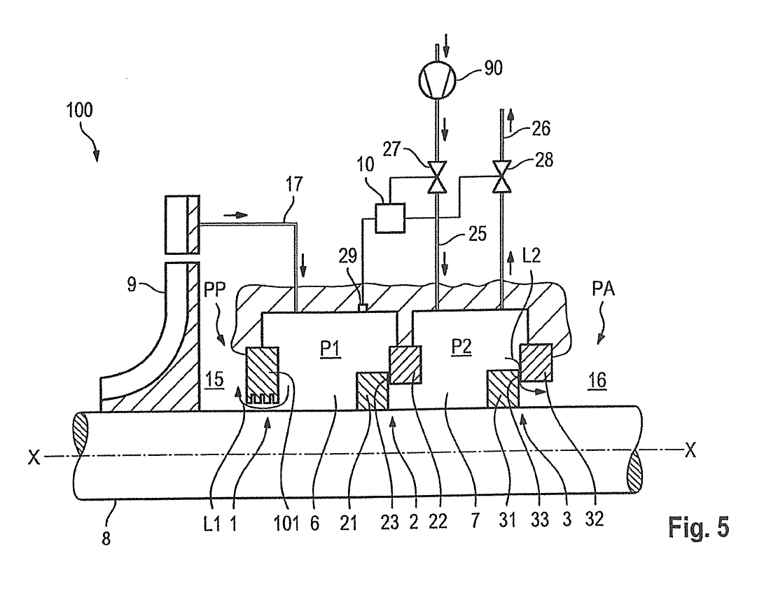

FIG. 5 shows a schematic sectional view of a shaft seal arrangement according to a fifth exemplary embodiment of the invention,

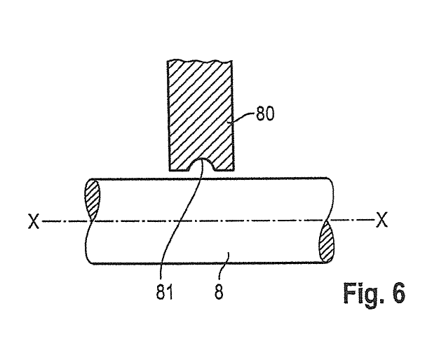

FIG. 6 shows a schematic sectional view of an alternative radial gap seal for the use in a shaft seal arrangement according to the invention,

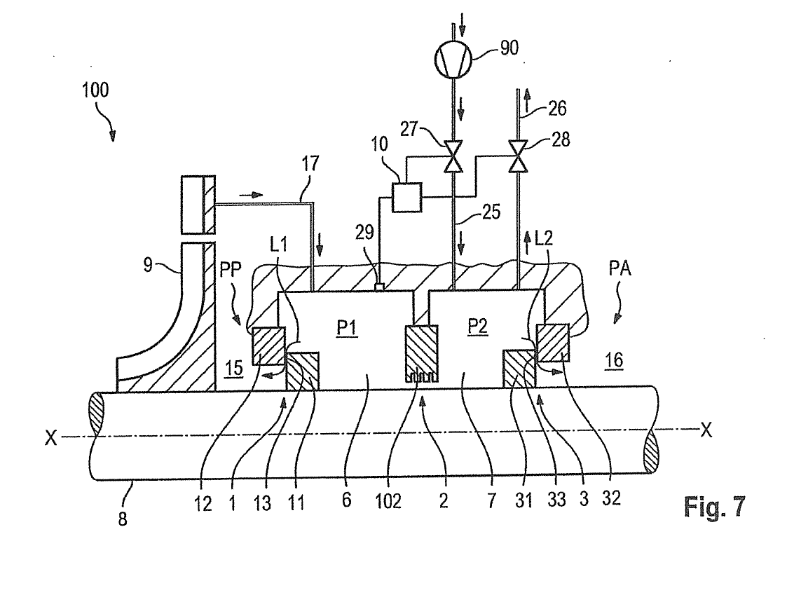

FIG. 7 shows a schematic sectional view of a shaft seal arrangement according to a sixth exemplary embodiment of the invention,

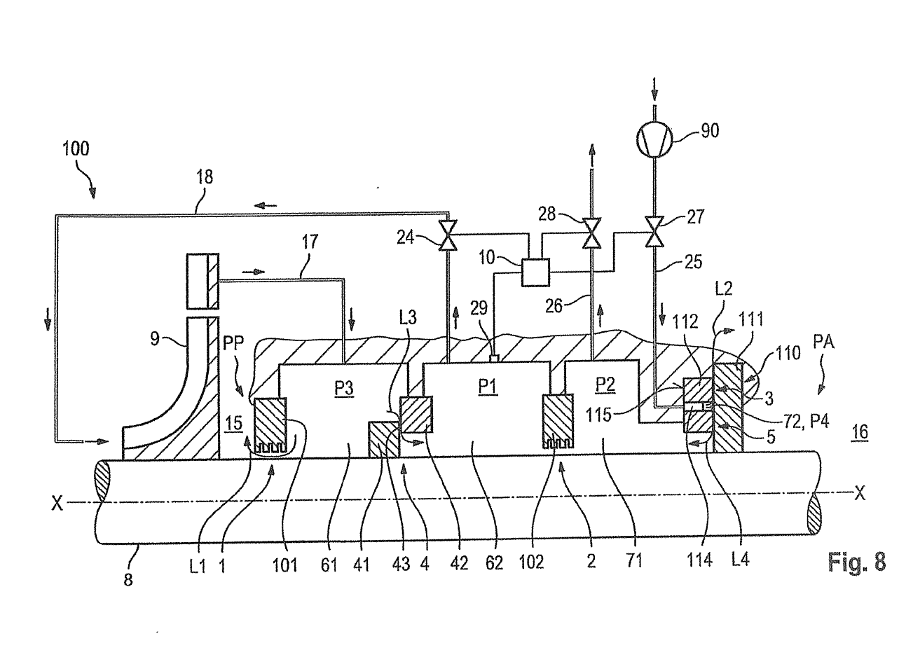

FIG. 8 shows a schematic sectional view of a shaft seal arrangement according to a seventh exemplary embodiment of the invention, and

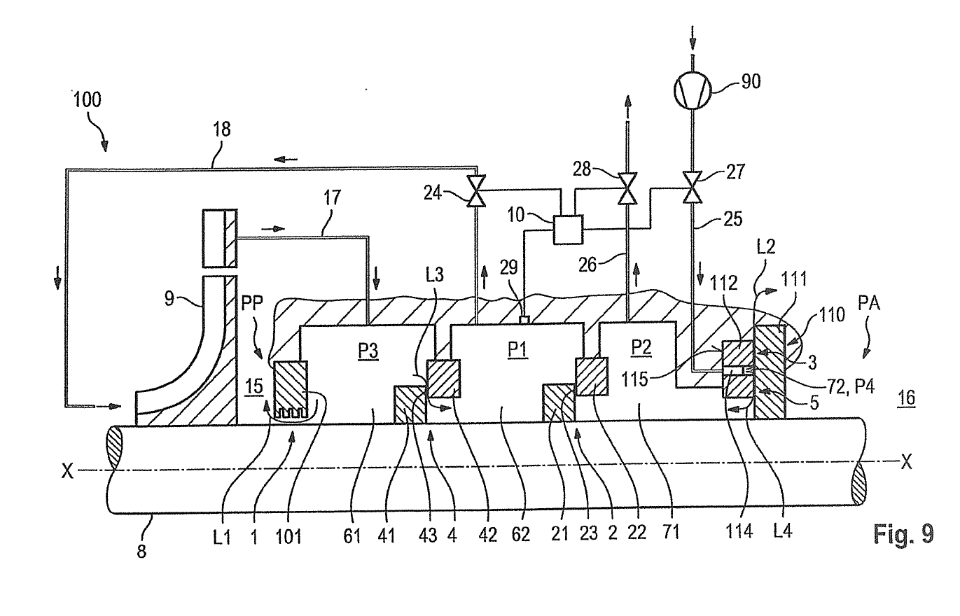

FIG. 9 shows a schematic sectional view of a shaft seal arrangement according to an eighth exemplary embodiment of the invention.

In the following, a shaft seal arrangement 1 according to a first exemplary embodiment of the invention is described in detail by referring to FIG. 1.

As can be seen from FIG. 1, the shaft seal arrangement 100 comprises a first seal 1, a second seal 2, and a third seal 3. Here, the three seals are arranged in series 8 in the axial direction X-X at a shaft, running from a product side 15 to an atmosphere side 16. Thus, the shaft seal arrangement 100 seals off a product side 15 from the atmosphere side 16. At the product side 15, a turbine 9 that conveys a product medium is provided, which may for example be dangerous for the environment. Here, a product pressure PP is present at the product side 15, while an atmospheric pressure PA is present at the atmosphere side 16.

The first, second and third seal 1, 2, 3 are all embodied as gas-lubricated mechanical seals, with the first seal 1 comprising a rotating mechanical seal 11 and a stationary mechanical seal 12 and a sealing gap 13 being defined in between them. The second seal 2 comprises a rotating mechanical seal 21 and a stationary mechanical seal 22, with a sealing gap 23 being defined in between them. The third seal 3 comprises a rotating mechanical seal 31 and a stationary mechanical seal 32, with a sealing gap 33 being defined in between them.

Preferably, both mechanical seals 21, 22 of the second seal 2 have a diamond coating.

As can be seen from FIG. 1, a first space 6 is formed between the first seal 1 and the second seal 2. The first space 6 has a first pressure P1. A second space 7 is formed between the second seal 2 and the third seal 3. A second pressure P2 is present in the second space 7.

The first space 6 is connected to the product side 15 via a product supply line 17. In this way, the product medium can be supplied from the product side 15 to the first space 6. The product medium is extracted at the corresponding site at the product side 15 in accordance with the desired pressure level in the first space 6.

The second space 7 is supplied with a pressure medium via a pressure supply line 25. Just like the product medium, the pressure medium is also gaseous. The product medium is conveyed by means of a compressor 90. A first throttling device 27 is arranged inside the pressure supply line 25.

Further, a pressure return line 26 branches off from the second space 7. A second throttling device 28 is arranged inside the pressure return line 26.

The shaft seal arrangement 100 further comprises a control unit 10. The control unit 10 is connected to the first and the second throttling device 27, 28. Further, a sensor 29 for detecting the first pressure is arranged at the first space 6. The sensor 29 transmits the respective pressure level present in the first space 6 to the control unit 10.

The control unit 10 is now configured in such a manner that by controlling the first and the second throttling device 27, 28 a pressure level in the second space 7 is controlled in such a manner that the first pressure P1 in the first space is equal to the first pressure P2 in the second space, or that it is substantially equal to the same. What is meant by “substantially equal” according to the invention is that a pressure difference between the first pressure P1 and the second pressure P2 is less than 1%, in particular less than 0.5%. In this way, it is achieved that the second seal 2 can be operated in a pressure-compensated manner. In other words, the second seal 2 can be operated with a pressure difference ΔP of zero. In this way, it is prevented that the product medium present in the first space 6 leaks into the second space 7 via the second seal. According to the invention, a zero leakage can thus be achieved by providing two spaces that are separated from each other by a gas-lubricated mechanical seal (second seal 2) in which the same pressure is present.

As is indicated in FIG. 1, there is only a small first leakage L1 from the first space 6 to the product side 15. Similarly, there is a small second leakage L2 from the second space 7 to the atmosphere side 16. There is no leakage via a pressure-compensated middle seal (second seal).

It should further be noted that it is of course also possible that the control unit 10 controls the pressure in the second space 7 only by selecting of one of the two throttling devices 27, 28. That is, the pressure control in the first space can be also achieved by controlling only the first throttling device 27 or by controlling only the second throttling device 28. However, preferably both throttling devices 27, 28 are controlled, as in this way a faster control intervention is facilitated in the case that there are pressure fluctuations in the first space 6, as they may occur during operation of the turbine 9.

Thus, according to the invention, a middle seal of the plurality of seals is operated with a pressure difference of zero. Here, the pressure inside the spaces adjacent to the middle seal is maintained at the same level. Thus, any leakage via the middle seal can be reliably prevented. The two spaces adjacent to the middle seal are sealed off by at least one product-side seal (first seal) and an atmosphere-side seal (third seal). Thus, for example in applications in power stations, the previously used elaborate oil seals with complicated leakage recirculation systems and separating devices for separating the product medium from a sealing medium can be dispensed with. According to the invention, no leakage recirculation system has to be provided in the first space 6 for the product medium that is used for sealing. Although a first leakage L1 occurs via the first seal 1, it is very small, so that the operation of the shaft seal arrangement according to the invention is rendered highly economical. As for the second space 7, also only an extremely small second leakage L2 takes place from the second space 7 to the atmosphere side 16, whereby the high economic efficiency of the invention is also supported.

Here, the first leakage L1 is guided back to the product side 15 into an area with a lower pressure. In this way, the pressure difference between the first space 6 and the pressure at the product side 15 is not excessively high.

Further, according to the invention, sealing at high rotational speeds of the turbine, in particular in the range of 40 m/s to 140 m/s, can also be facilitated by using the shaft seal arrangement 100, without any changes in the design of the shaft seal arrangement 100 being necessary. Here, oil seals can only provide a sealing up to a rotational speed of approximately 80 m/s.

In order to prevent any leakage of the product medium via the second seal 2 in a highly reliable manner, the first pressure P1 is slightly higher than the second pressure P2, for example within a range of a pressure difference of less than 0.1%.

FIG. 2 shows a shaft seal arrangement 100 according to a second exemplary embodiment of the invention.

As can be seen from FIG. 2, the shaft seal arrangement 100 of the second exemplary embodiment comprises exactly four seals. More specifically, the shaft seal arrangement comprises a first seal 1, a second seal 2, a third seal 3, and a fourth seal 4.

The fourth seal 4 is arranged between the first seal 1 and the second seal 2. The fourth seal 4 comprises a rotating mechanical seal 41, a stationary mechanical seal 42, and a sealing gap 43 that is arranged between the mechanical seals. The fourth seal 4 divides the first space of the first exemplary embodiment into a first subspace 61 and a second subspace 62. Thus, the shaft seal arrangement of the second exemplary embodiment comprises exactly four seals and exactly three spaces that are provided between the seals that are arranged in series at the shaft 8.

At that, the product supply line 17 supplies product medium to the first subspace 61. From the second subspace 62, a product return line 18 leads back to the product side 15, preferably to a location in the process with a low static pressure which is lower than the pressure P1 in the subspace 62. Here, a third pressure P3 in the first subspace 61 is slightly higher than the first pressure P1 in the second subspace 62. Just as in the first exemplary embodiment, the first pressure P1 in the second subspace 62 is equal or substantially equal to the pressure P2 in the second space 7. The third pressure P3 in the first subspace 61 is also slightly higher than the product pressure PP, so that a small first leakage L1 occurs from the first subspace 61 to the product side 15.

As in the first exemplary embodiment, a pressure difference between the second subspace 62, inside of which the first pressure P1 is present, and the second space 7, inside of which the second pressure P2 is present, is zero or tends towards zero. This is controlled by means of the first control unit 10. In addition, the product return line 18 branches off from the second subspace 62. Here, the product return line 18 has a relatively small cross-section. This cross-section as well as the length of the product return line 18 cause the recirculated medium to be throttled. It should be understood that it is also possible to install an additional controllable throttling device inside the product return line 18, like in the pressure supply line 25 or the pressure return line 26. As can be seen in FIG. 2, a sensor 29 is further arranged at the second subspace 62 in order to detect the first pressure P1 in the second subspace 62.

In the second exemplary embodiment, all four seals are embodied as gas-lubricated mechanical seals. Also in this exemplary embodiment, it is avoided that the product medium reaches the second space 7 and from there is discharged into the atmosphere in an undesirable manner, which is achieved by the second seal 2 being operatable with a pressure difference LIP of zero and the pressures P1, P2 in the second subspace 62 and the second space 7 being equal, or a pressure difference between these two spaces tending towards zero. The pressures P1 and P2 are in turn higher than the atmospheric pressure PA. A third leakage L3 is then recirculated from the first subspace 61 to the second subspace 62 via the product return line 18.

Otherwise, this exemplary embodiment corresponds to the first exemplary embodiment, so that it may be referred to the description provided in connection with the same.

FIG. 3 shows a shaft seal arrangement 100 according to a third exemplary embodiment of the invention.

As can be seen from FIG. 3, the shaft seal arrangement 100 of the third exemplary embodiment comprises a first seal 1, a second seal 2, a third seal 3, a fourth seal 4, and a fifth seal 5. Again, the five seals are arranged in series at the shaft 8.

The fifth seal 5 is arranged between the second seal 2 and the third seal 3. The fifth seal 5 divides the second space 7 into a third subspace 71 and a fourth subspace 72. Thus, in total the shaft seal arrangement 100 of the third exemplary embodiment has five seals and four spaces arranged in between them. Here, a fourth pressure P4 in the fourth subspace 72 is higher than a second pressure P2 in the third subspace 71. What thus results is a small fourth leakage L4 from the fourth subspace 72 to the third subspace 71 via the fifth seal 5.

All five seals in this exemplary embodiment are again embodied as gas-lubricated mechanical seals. The fifth seal 5 comprises a rotating mechanical seal 51, a stationary mechanical seal 52 and a sealing gap 53 arranged between the rotating and stationary mechanical seal.

The second pressure P2 in the third subspace 71 can in particular be controlled by controlling the second throttling device 28 inside the pressure return line 26 by means of the control unit 10. Here, a pressure difference between the second subspace 62 and the third subspace 71 is zero or goes towards zero, just as it has been described in the previous exemplary embodiments. Thus, the second seal 2 can again be operated with a pressure difference of zero, so that no leakage occurs from the second subspace 62 to the third subspace 71 via the second seal 2.

FIG. 4 shows a shaft seal arrangement 100 according to a fourth exemplary embodiment of the invention. Here, the fourth exemplary embodiment substantially corresponds to the first exemplary embodiment, wherein, in contrast to the first exemplary embodiment, the fifth seal 5 and the third seal 3 are integrated inside a common seal 110.

As can be seen from FIG. 4, the common seal 110 comprises a common rotating mechanical seal 111 and a common stationary mechanical seal 112. A feed line 114 is provided in the stationary mechanical seal 112, leading from a rear side 115 of the stationary mechanical seal 112 to the sliding surfaces of the mechanical seals. Here, the fourth subspace 72 is formed in the area of the sliding surfaces (cf. FIG. 4).

The pressure medium that is supplied via the supply line 25 is guided through the feed line 114 inside the stationary mechanical seal 112 to the fourth subspace 72. From the fourth subspace 72, a second leakage L2 to the atmosphere side 16 and a fourth leakage L4 into the third subspace 71 then takes place.

This arrangement has the special characteristic that a smaller axial installation length is possible, since the third and the fifth seal can be integrated into a common seal 110. Otherwise, this exemplary embodiment corresponds to the third exemplary embodiment, so that it may be referred to the description provided in connection with the same.

As can further be seen from FIG. 4, a third throttling device 24 is provided inside the product return line 18 in order to control a pressure level in the second subspace 62 and thus also in the first subspace 61.

FIG. 5 shows a shaft seal arrangement 100 according to a fifth exemplary embodiment of the invention. In the fifth exemplary embodiment, a radial gap seal 101 is provided as the first seal 1 instead of a mechanical seal. The radial gap seal 101 is a labyrinth seal with a labyrinth that is facing towards the shaft 8. The first leakage Li which occurs via the radial gap direction 101 is again guided towards the product side 15 in an area with a lower pressure.

Instead of the labyrinth seal of FIG. 5, alternatively a carbon ring seal 80 with a circumferential indentation 81 can be used, as shown in FIG. 6. The carbon ring seal 80 is also a radial gap seal, wherein particularly the carbon ring seal 80 can be provided in a cost-effective manner. As can be seen from FIG. 6, the circumferential indentation is oriented towards the lateral surface of the shaft 8 and preferably formed centrally in the carbon ring seal 80.

FIG. 7 shows a shaft seal arrangement 100 according to a sixth exemplary embodiment of the invention. In the sixth exemplary embodiment, the second seal 2 is formed as a radial gap seal 102. Since the two spaces 6 and 7 that are adjacent to the second seal 2 are maintained at the same pressure level, no leakage occurs via the second seal 2. The radial gap seal 102 used in the second seal 2 is also embodied as a labyrinth seal. Alternatively, the carbon ring seal 80 shown in FIG. 6 can also be used.

FIG. 8 shows a shaft seal arrangement 100 according to a seventh exemplary embodiment of the invention. In the seventh exemplary embodiment, which substantially corresponds to the fourth exemplary embodiment shown in FIG. 4, the first seal 1 and the second seal 2 are replaced by the radial gap seals 101 and 102. In the seventh exemplary embodiment shown in FIG. 8, both radial gap seals 101 and 102 are provided as labyrinth seals. Alternatively, the two radial gap seals 101 and 102 can also be embodied as carbon ring seals, as shown in FIG. 6.

FIG. 9 shows a shaft seal arrangement 100 according to an eighth exemplary embodiment of the invention. The eighth exemplary embodiment substantially corresponds to the seventh exemplary embodiment that is shown in FIG. 8, wherein only one of the mechanical seals is replaced by a radial gap seal 101. As can be seen from FIG. 9, the first seal 1 is provided as a radial gap seal 101. The radial gap seal 101 of this exemplary embodiment is again provided as a labyrinth seal, wherein alternatively also the carbon ring seal shown in FIG. 6 can be used.

As for the shaft seal arrangements 100 described in FIGS. 5 to 9, which respectively have at least one radial gap seal, it should be noted that a major advantage of the radial gap seal is its axially shorter design as compared to a mechanical seal. In this way, an axial installation space in the axial direction X-X of the shaft 8 can be saved. Particularly when it comes to applications in the field of large-scale machinery, such as for example turbines and compressors in power plants and other large equipment, the axial installation spaces that are available at the end of the turbine or of the compressor are very limited. Thus, the use of at least one radial gap seal results in a major cost advantage. Another advantage of radial gap seals as compared to mechanical seals is that they are easy to operate as well as highly robust. In addition, radial gap seals are considerably more cost-effective than mechanical seals.

To sum up, it can be stated for all exemplary embodiments that according to the invention also a method for operating the shaft seal arrangement 100 is provided, in which a second seal 2, which represents a middle seal between a product-side seal (seal 1) and an atmosphere-side seal (seal 3), is operated with a pressure gradient of zero or close to zero. At that, the middle seal is preferably a gas-lubricated mechanical seal, preferably with a diamond coating, or alternatively a radial gap seal, wherein the two are maintained at the same pressure level (first pressure P1 and second pressure P2) or at approximately the same pressure level at the spaces adjacent to the middle seal. In particular, it is always ensured by means of the control unit 10 that the second pressure P2 of the pressure medium is minimally higher than the first pressure P1 of the product medium in order to avoid any leakage of the product medium into the pressure medium and thus any spilling of the product medium.

Another major advantage of the present shaft seal arrangement according to the invention is that the use of elaborate and expensive leakage recirculation systems can be foregone. The cost may be further reduced if the mechanical seals that are used in the first to fourth exemplary embodiments can be partially replaced with radial gap seals. In this way, the axial installation space of the shaft seal arrangement can be significantly reduced and further considerable cost savings can be achieved through a shorter axial structure of the machines.

### PARTS LIST

1 first seal
2 second seal
3 third seal
4 fourth seal
5 fifth seal
6 first space
7 second space
8 shaft
9 turbine, compressor, runner
10 control unit
11 rotating mechanical seal
12 stationary mechanical seal
13 sealing gap
15 product side
16 atmosphere side
17 product supply line
18 product return line
21 rotating mechanical seal
22 stationary mechanical seal
23 sealing gap
24 third throttling device
25 pressure supply line
26 pressure return line
27 first throttling device
28 second throttling device
29 sensor
31 rotating mechanical seal
32 stationary mechanical seal
33 sealing gap
41 rotating mechanical seal
42 stationary mechanical seal
43 sealing gap
51 rotating mechanical seal
52 stationary mechanical seal
53 sealing gap
61 first subspace
62 second subspace
71 third subspace
72 fourth subspace
80 carbon ring seal
81 circumferential indentation
90 compressor
100 shaft seal arrangement
101 radial gap seal
102 radial gap seal
110 common seal
111 common rotating mechanical seal
112 common stationary mechanical seal
114 feed line
115 rear side of the common stationary mechanical seal
PP pressure at product side
PA pressure at atmosphere side
L1 first leakage towards the product side
L2 second leakage towards the atmosphere side
L3 third leakage
L4 fourth leakage
P1 first pressure
P2 second pressure
P3 third pressure
P4 fourth pressure
X-X axial direction

1. Shaft seal arrangement, comprising:
a first seal, a second seal and a third seal which are arranged in series between a product side to be sealed and an atmosphere side,
wherein the second seal is arranged between the first seal and the third seal,
wherein a first pressure (P1) is present in a space adjacent to the second seal in the direction towards the product side, and a second pressure (P2) is present in a space adjacent to the second seal in the direction towards the atmosphere side,
wherein the space adjacent to the atmosphere side is connected to a pressure supply line via which a pressure medium can be supplied into the space, and
wherein the first pressure (P1) is equal or substantially equal to the second pressure, (P2), so that the second seal can be operated with a pressure difference of zero between the first pressure (P1) and the second pressure (P2).

2. Shaft seal arrangement according to claim 1, wherein the second seal is a gas-lubricated mechanical seal with a rotating mechanical seal and a stationary mechanical seal.

3. Shaft seal arrangement according to claim 1, wherein the second seal is a radial gap seal, in particular a labyrinth seal or a carbon ring seal.

4. Shaft seal arrangement according to claim 1, wherein the first seal is a radial gap seal, in particular a labyrinth seal or a carbon ring seal.

5. Shaft seal arrangement according to claim 1, further comprising a control unit and a first throttling device that is arranged inside the pressure supply line and connected to the control unit, wherein the control unit is configured for controlling the second pressure (P2) by means of opening or closing the first throttling device depending on the first pressure (P1).

6. Shaft seal arrangement according to claim 1, wherein the second seal has a diamond coating at least at one of the mechanical seals.

7. Shaft seal arrangement according to claim 1, wherein the pressure medium that is supplied via the pressure supply line is air or nitrogen.

8. Shaft seal arrangement according to claim 1, further comprising a pressure return line which branches off from the space of the second seal which is facing towards the atmosphere side.

9. Shaft seal arrangement according to claim 8, wherein a second throttling device is arranged inside the pressure return line and is connected to the control unit, wherein the control unit is configured for controlling the second pressure (P2) by means of opening or closing the second throttling device depending on the first pressure (P1).

10. Shaft seal arrangement according to claim 1, further comprising a fourth seal which is arranged between the first seal and the second seal, wherein the fourth seal defines a first subspace between the first seal and the fourth seal, and defines a second subspace between the fourth seal and the second seal, wherein the first subspace is connected to the product side and a product return line leads back from the second subspace into the process, wherein a third pressure (P3) is present in the first subspace which is higher than a pressure in the second subspace, wherein the first pressure (P1) is present in the second subspace, and wherein the second pressure (P2) in the second space is equal or substantially equal to the first pressure (P1).

11. Shaft seal arrangement according to claim 10, further comprising a fifth seal which is arranged between the second seal and the third seal, wherein a third subspace is defined between the fifth seal and the second seal and a fourth subspace is defined between the fifth seal and the third seal, wherein the second pressure (P2) is present in the third subspace, the fourth subspace is connected to the pressure supply line, the pressure return line branches off from the third subspace, and a fourth pressure (P4) that is higher than the second pressure (P2) is present in the fourth subspace.

12. Shaft seal arrangement according to claim 11, wherein the third seal and the fifth seal are integrated inside a common seal, wherein the common seal has a common rotating mechanical seal and a common stationary mechanical seal, wherein a feed line runs inside the stationary mechanical seal from its rear side to the sliding surfaces of the mechanical seals, wherein the feed line is connected to the pressure supply line, and the fourth subspace is arranged at the sliding surfaces of the two mechanical seals at the end of the feed line.

13. Shaft seal arrangement claims 10, wherein a third throttling device is arranged inside the product return line and connected to the control unit, wherein the control unit is configured for controlling the first pressure (P1) by means of opening and closing the third throttling device.

14. Shaft seal arrangement according to claim 5, wherein all seals are gas-lubricated mechanical seals.

15. Fluid machine, in particular turbine or compressor, comprising a shaft to be sealed and a shaft seal arrangement according to claim 1.

16. Method for operating a shaft seal arrangement, comprising a first seal, a second seal and a third seal which are arranged in series at a shaft, wherein a first space is defined between the first seal and the second seal, and a second space is defined between the second seal and the third seal, wherein a product medium to be sealed is supplied to the first space, and a pressurized pressure medium is supplied to the second space, wherein a pressure in the first space and in the second space is controlled in such a manner that a first pressure (P1) in the first space is equal to the second pressure (P2), or that the first pressure (P1) is substantially equal to the second pressure (P2) in the second space, so that the second seal can be operated without or with only a minimal pressure gradient between the first pressure (P1) and the second pressure (P2).

17. Method according to claim 16, wherein the second pressure (P2) is controlled by means of a throttling device depending on the first pressure (P1).

18. Method according to claim 16, wherein the first pressure (P1) of the product medium is controlled by means of a throttling device after having been extracted from the product side.
